(19) United States
(12) Patent Application Publication
(10) Pub. No.: US 2013/0275692 A1
(43) Pub. Date: Oct. 17, 2013

(54) STORAGE DEVICE AND METHODS THEREOF

(71) Applicant: Shak Loong Kwok, Tustin, CA (US)

(72) Inventor: Shak Loong Kwok, Tustin, CA (US)

(21) Appl. No.: 13/447,907

(22) Filed: Apr. 16, 2012

(51) Int. Cl. G06F 12/00

(52) U.S. Cl. 711/156; 711/E12.001

(57) ABSTRACT

A non-volatile mass memory storage device for storing information for a computing device and methods thereof are provided. The device includes a storage media having a plurality of non-volatile memory storage blocks for storing information; a non-volatile memory for storing a non-volatile data structure for storing a state of the plurality of storage blocks indicating whether a block is defective, valid, invalid or free; and a volatile memory for storing a translation data structure for responding to read and write requests for reading and writing information at the storage media. When the storage device is powered up, the state information is used to rebuild the translation data structure.

### TECHNICAL FIELD

The present disclosure relates to storage devices.

### BACKGROUND

Electronic data usage today continues to increase with the rapid rise of the Internet, electronic commerce, social media, use of computing devices and other technological changes. Solid state (i.e. non-volatile) storage devices (SSDs) are becoming popular as mass storage device used by computing systems for storing electronic data. The storage capacity of SSDs continues to increase with the increase in user demand for storing electronic data. Continuous efforts are being made to efficiently manage and use SSDs.

### SUMMARY

In one embodiment, a non-volatile mass memory storage device for storing information for a computing device is provided. The device includes a storage media having a plurality of non-volatile memory storage blocks for storing information. The device also include a micro-processor having access to a non-volatile memory for storing a non-volatile data structure used for storing a plurality of states for the plurality of storage blocks.

The plurality of states include a first state indicating that one or more of the plurality of blocks are defective; a second state indicating that one or more of the plurality of blocks are valid and are being used to store information; a third state indicating that one or more of the plurality of blocks are free for allocation to store information; and a fourth state indicating that one or more of the plurality of blocks are invalid and are ready to be erased. When the storage device is powered up, state information is used to rebuild a translation data structure used by the micro-processor for responding to read and write requests for reading and writing information.

In another embodiment, a non-volatile mass memory storage device for storing information for a computing device is provided. The device includes a storage media having a plurality of non-volatile memory storage blocks for storing information. The device also includes a non-volatile memory for storing a non-volatile data structure used for storing a state of the plurality of storage blocks indicating that one or more of the plurality of blocks are defective; one or more of the plurality of storage blocks are valid and are being used to store information; one or more of the plurality of storage blocks are free for allocation to store information; and one or more of the plurality of blocks are invalid and are ready to be erased. When the storage device is powered up, state information is used to rebuild a translation data structure stored at a volatile memory device and used for responding to read and write requests for reading and writing information at the storage media.

In yet another embodiment, a non-volatile mass memory storage device for storing information for a computing device is provided. The device includes a storage media having a plurality of non-volatile memory storage blocks for storing information; a non-volatile memory for storing a non-volatile data structure for storing a state of the plurality of storage blocks indicating whether a block is defective, valid, invalid or free.

The device also includes a volatile memory for storing a translation data structure for responding to read and write requests for reading and writing information at the storage media. When the storage device is powered up, the state information is used to rebuild the translation data structure.

This brief summary has been provided so that the nature of this disclosure may be understood quickly. A more complete understanding of the disclosure can be obtained by reference to the following detailed description of the various embodiments thereof in connection with the attached drawings.

### BRIEF DESCRIPTION OF THE DRAWINGS

The foregoing features and other features will now be described with reference to the drawings of the various embodiments. In the drawings, the same components have the same reference numerals. The illustrated embodiments are intended to illustrate, but not to limit the present disclosure. The drawings include the following Figures:

FIG. 1A shows an example of a processing system, used according to one embodiment;

FIG. 1B shows an example of a conventional power module for a conventional non-volatile storage device;

FIG. 1C shows a block diagram of a non-volatile storage device, according to one embodiment;

FIG. 1D shows an example of a storage media layout, used according to one embodiment;

FIG. 1E shows an example of a layout of a block of the storage media, according to one embodiment;

FIGS. 1F-1H show examples of various data structures, generated and used according to one embodiment; and

FIGS. 2A-2B and 3 show process flow diagrams, according to one embodiment.

### DETAILED DESCRIPTION

As a preliminary note, as used in this disclosure, the terms “component” “module”, “system,” and the like are intended to refer to a computer-related entity, either software/firmware-executing general purpose processor, hardware, firmware and a combination thereof. For example, a component may be, but is not limited to being, a process running on a processor, a processor, an object, an executable, a thread of execution, a program, firmware instructions and/or a computer.

By way of illustration, both an application running on a computing system and the computing system can be a component. One or more components may reside within a process and/or thread of execution and a component may be localized on one computer and/or distributed between two or more computers. Also, these components can execute from various computer readable media having various data structures stored thereon.

Computer executable components can be stored, for example, on non-transitory computer readable media including, but not limited to, an ASIC (application specific integrated circuit), CD (compact disc), DVD (digital video disk), ROM (read only memory), floppy disk, hard drive, EEPROM (electrically erasable programmable read only memory), memory stick or any other storage device, in accordance with the claimed subject matter.

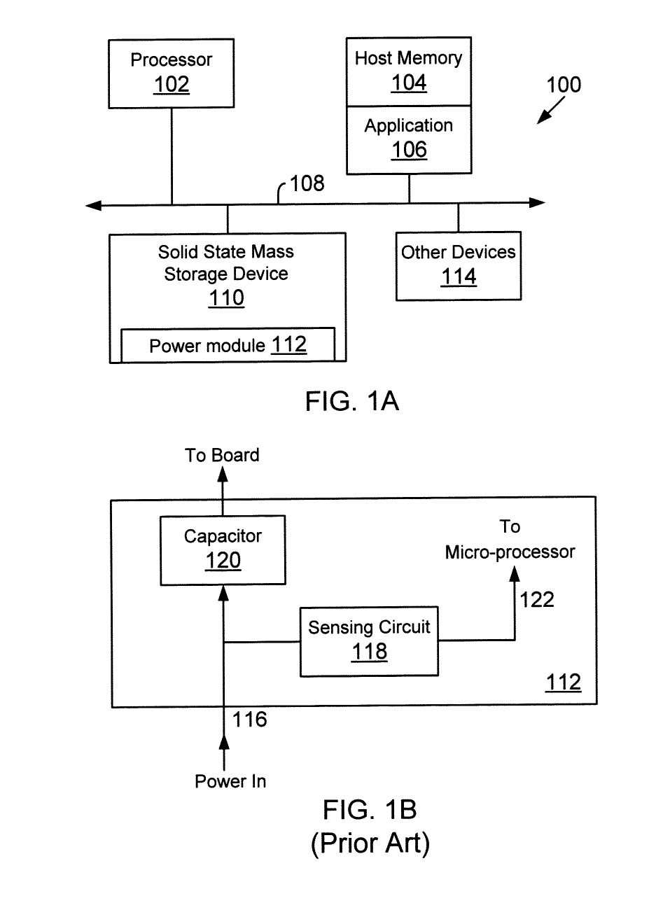

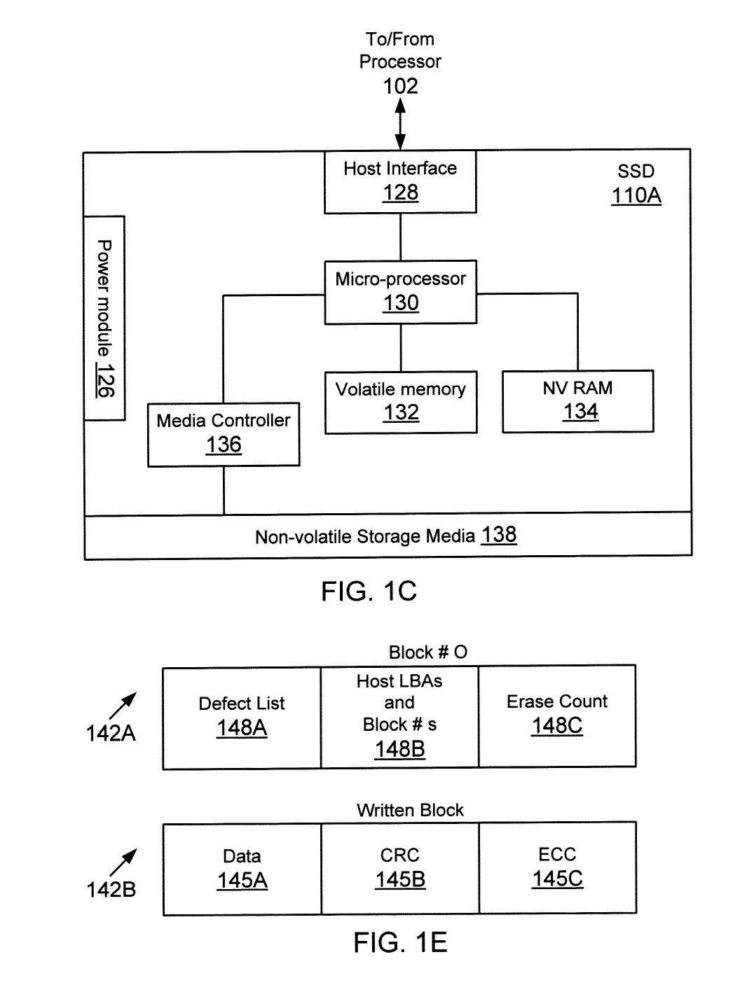

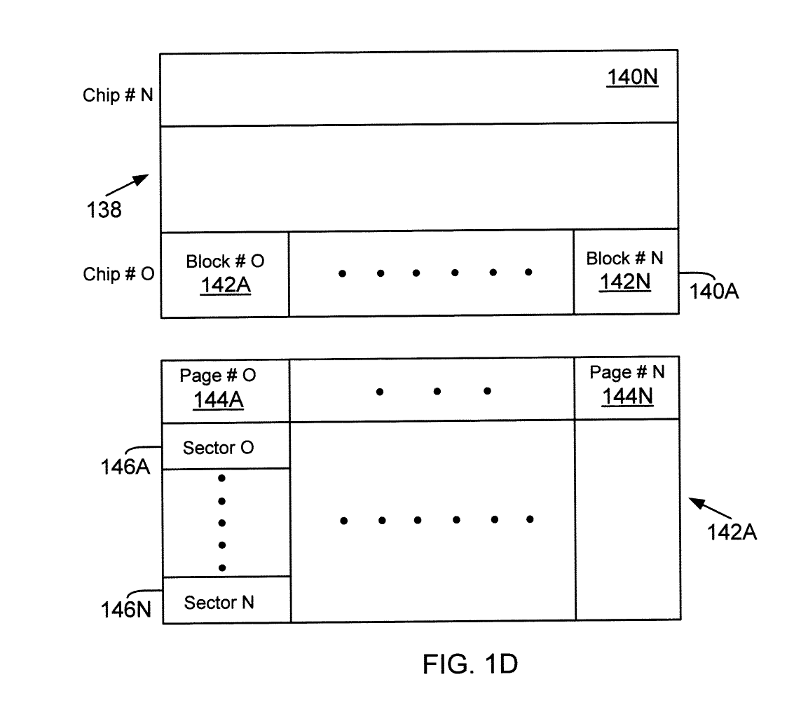

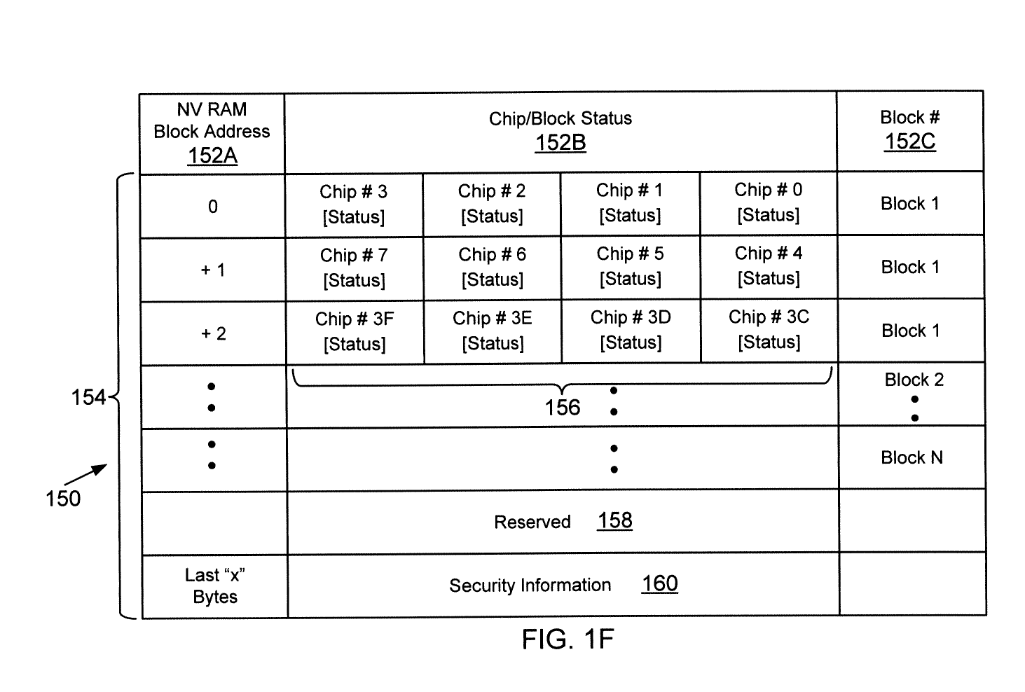

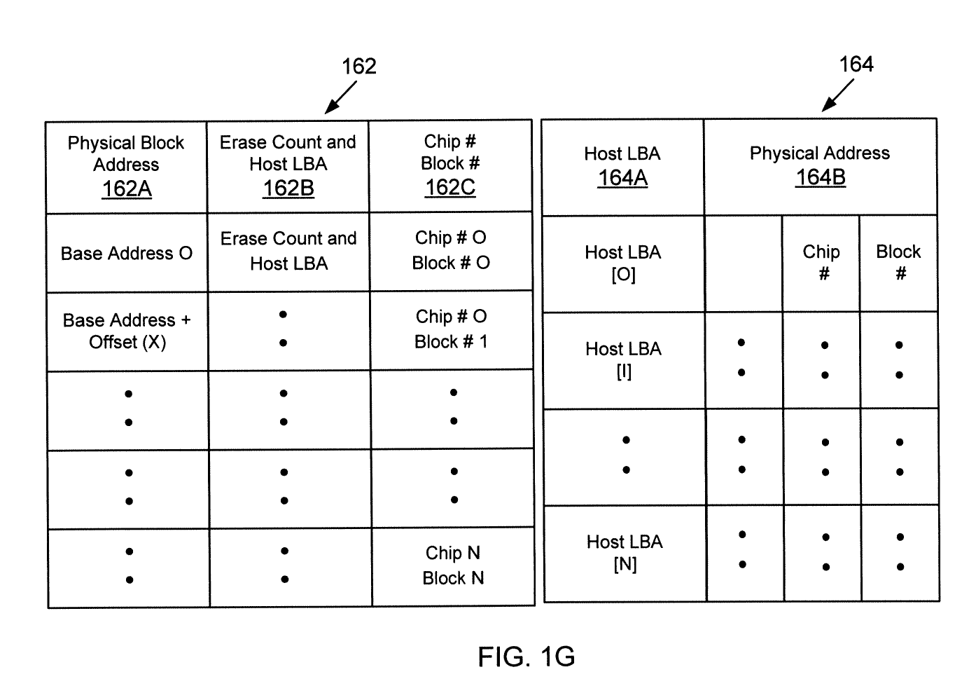

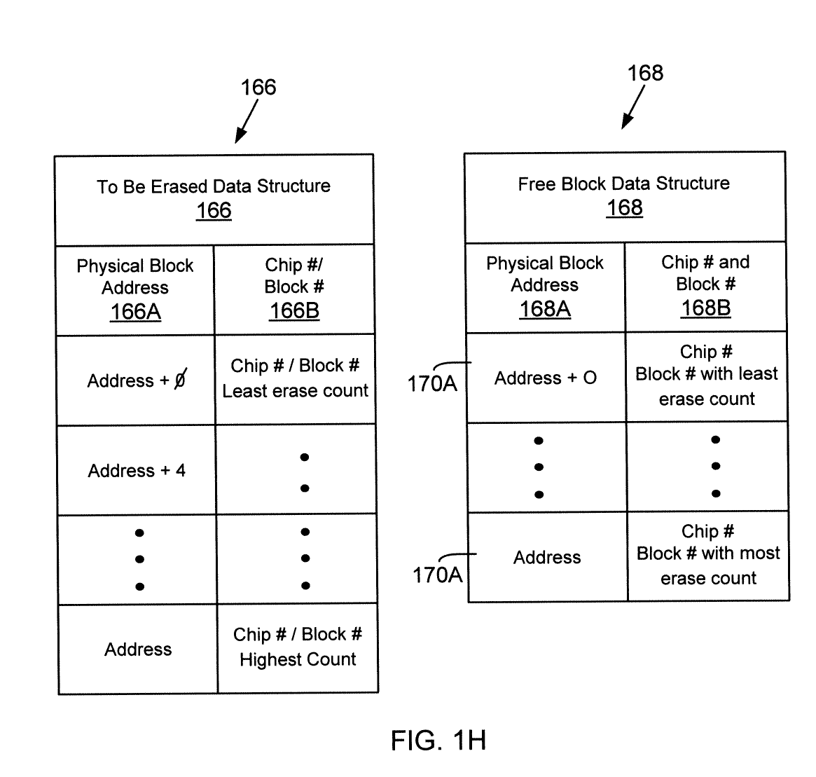

Processing System: FIG. 1A is a high-level block diagram showing an example of the architecture of a processing system (may also be referred to as host system) 100 that may be used according to one embodiment. The processing system 100 includes one or more processor(s) 102 (may also be referred to as host processor 102) and memory 104 (may also be referred to as host memory 104), coupled to a bus system 108. The bus system 108 is an abstraction that represents any one or more separate physical buses and/or point-to-point connections, connected by appropriate bridges, adapters and/or controllers. The bus system 108, therefore, may include, for example, a system bus, a Peripheral Component Interconnect (PCI) bus, a HyperTransport or industry standard architecture (ISA) bus, a small computer system interface (SCSI) bus, a universal serial bus (USB), an Institute of Electrical and Electronics Engineers (IEEE) standard 1394 bus (sometimes referred to as “Firewire”) or any other interconnect type.

The processor(s) 102 are the central processing units (CPUs) of the host system 100 and, thus, control its overall operation. The processor 102 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The processing system 100 may include other devices/components 114 for example, input/output (I/O) devices including a display device, a keyboard, a mouse and others, a network adapter for connecting with other network devices, a storage adapter if the processing system is being used as a server, or any other device type. The details of such devices have not been provided since they are not germane to the adaptive embodiments of the present disclosure.

Memory 104 represents any form of random access memory (RAM), read-only memory (ROM), flash memory, or the like, or a combination of such devices. In certain embodiments, processor 102 executes instructions stored in memory 104. Instructions, for example, application 106 may be executed by processor 102 from memory 104. As an example, application 106 may send read and write commands to a solid state mass storage device 110 (may also be referred to as SSD 110) that is coupled via bus 108 or any other interconnect type.

In one embodiment, SSD 110 is a mass storage device having non-volatile storage media for storing information. An example of such non-volatile storage media includes NAND based non-volatile memory, NOR based non-volatile memory or any other non-volatile media type. It is noteworthy that although the adaptive embodiments described herein are based on SSD 110, the embodiments are applicable to any storage device type.

To read and/or write information to and from SSD 110, application 106 may send a read and/or write command with a logical block address (LBA). The SSD 110 maintains a mapping (or translation) data structure that maps host LBAs with physical addresses where data is stored or will be stored for a write command. The SSD 110 provides the data for the read command and writes data for the write command.

SSD 110 typically uses a volatile memory (for example, a double data rate volatile memory (may also be referred to as DDR memory) for storing the mapping structure. If SSD 110 loses power, then conventional systems use power module 112 for transferring the mapping data structure from the DDR memory to a non-volatile media. This approach has limitations, as described below, with respect to FIG. 1B.

FIG. 1B shows a block diagram of power module 112 as used in conventional SSDs. Power module 112 receives power via a pin 116. The power is received by a sensing circuit 118 and is also used to charge a capacitor 120. The sensing circuit 118 senses the incoming power input to make sure that SSD 110 is receiving adequate power. If the power is disrupted, then sensing circuit 118 generates a notification 122 (for example, an interrupt) for a microprocessor. The micro-processor then uses the charge stored in capacitor 120 to transfer the mapping data structure from the DDR to the non-volatile media so that when power is restored the mapping data structure can be retrieved from the non-volatile media.

This approach has various limitations. First, for example, capacitor 120 needs to be large because the mapping data structure is getting larger as storage capacity increases. For example, it may take 4 bytes to store an address and hence one may need hundreds of megabytes to store the mapping data structures. This would require a large capacitor with a lot of charge to enable the data transfer.

Second, the reliability of capacitor 120 decreases as the amount charge size that the capacitor stores increases. The mean-time-before-failure (MTBF) for capacitor 120 may be shorter than a life time guarantee of the SSD. Hence, this may cause the SSD to fail prematurely.

Third, capacitor 120 is a passive component and if it fails, one can lose the mapping data structure during a power failure. Therefore, it is not desirable to rely on capacitor 120 for recovery after a power failure.

Fourth, when SSD 110 is powered up after a power down it may experience another power outage. If the subsequent power outage occurs shortly after the power up, then capacitor 120 may not have had enough time to get charged. This may result in disruption and SSD 110 be unusable.

SSD 110A: The embodiments described herein provide methods and systems where one does not have to rely on a capacitor 120 for recovery. FIG. 1C shows a block diagram of SSD 110A, according to one embodiment, with a power module 126 that may not need capacitor 120 or the sensing circuit 118.

In one embodiment, SSD 110A includes a host interface 128 to interface with host processor 102 or any other component of processing system 100. The structure of host interface 128 will depend on the protocol/standard used for communication between SSD 110A and processor 102. For example, if SSD 110A is coupled using a SATA interface, then host interface 128 includes logic and circuitry for handling SATA commands/signaling. The embodiments disclosed herein are not limited to any particular protocol or interface type.

SSD 110A may also include a micro-processor (may also be referred to as a micro-controller) 130 for controlling overall operations of SSD 110A. Micro-processor 130 may include a programmable reduced instruction set computing processor (RISC), general-purpose or special-purpose microprocessors, digital signal processors (DSPs), programmable controllers, application specific integrated circuits (ASICs), programmable logic devices (PLDs), field programmable gate array (FPGA), or the like, or a combination of such hardware based devices.

Micro-processor 130 has access to a volatile memory (DDR) 132 and a non-volatile random access memory 134 (may also be referred to as NVRAM 134. The various data structures of DDR 132 and NVRAM 134 are used by micro-controller 130 for managing read and write operations, as described below in detail.

SSD 110A includes non-volatile storage media 138 (may also be referred to as storage media 138) that is controlled by a media controller 136. The media controller 136 interfacing with micro-processor 130 reads, writes and erases memory storage blocks at storage media 138.

Storage Media Layout: FIG. 1D shows a high level layout of storage media 138, used according to one embodiment. Storage media 138 may include a plurality of chips 140A-140N. Each chip may have a plurality of blocks 142A-142N. Each block may have a plurality of pages 144A-144N. Each page may have a plurality of sectors 146A-146N. The block, page and sector size may vary based on storage media providers and are not limiting to the embodiments disclosed herein.

FIG. 1E shows a block diagram of block #0 142A for a chip, used according to one embodiment. Block #0 is typically guaranteed by a media manufacturer to be defect free. Block #0 is used to store a defect data structure 148A that provides a list of defects in a particular chip of storage media 138.

In one embodiment, Block #0 142A is also used to store the host LBAs and block numbers that are used for storing information at a particular chip. Each block may be assigned a starting host LBA number and then sectors in the block are assigned host LBA(n), LBA(n+1), LBA(n+2), up to the last sector. It is noteworthy that the embodiments disclosed herein are not limited to this addressing scheme. For example, the host LBAs of a particular block may be stored at the associated block itself. Thus, for example, a block #N may be used to store data starting from Page 1 of the block, while Page 0 of the block #N may be used to store host LBA associated with this block.

Block #0 142A, as shown in FIG. 1E may also be used to store an erase count 148C that is maintained by media controller 136 at block #0. It is noteworthy, that the erase count 148C may also be stored at the block itself with the host LBA. The embodiments disclosed herein are not limited to the location of the erase count 148C.

The erase count 148C provides a count of a number of times each block of a particular chip has been erased. The erase count 148C is maintained so that SSD 110A can track the number of erase operations for each block. A media manufacturer guarantees the media/block only for a certain number of erase operations. As described below in detail, SSD 110A uses the erase count to allocate blocks for writing data. Blocks with less erase count are used first. Therefore block “wear' is spread out among various chips, reducing the chance wearing out some chips faster than others.

FIG. 1E also shows a written block 142B. Data 145A is written in one portion of the block 142B. The cyclic redundancy code (CRC) 145B and error correction code (ECC) 145C may be written in another portion.

Data Structures: FIG. 1F shows an example of a data structure 150 (may also be referred to as NVRAM data structure 150) stored at NVRAM 134, according to one embodiment. The NVRAM data structure 150 may include a first segment 152A for storing NVRAM block addresses (or offset from a base address) shown as 154. For example, byte0 may be the base address and the next offset at byte1 will be the base address+1, and so on.

The data structure 150 includes a segment 152B for storing the state of the various blocks/chips of storage media 138, according to one embodiment. The block numbers associated with the various chip numbers are provided in segment 152C. As an example, under segment 152B is shown a segment 156 of data structure 150 for storing the states of various blocks within the plurality of chips of storage media 138. For example, the states of block 1 (shown in segment 152C) for chips 0, 1, 3, 4, 5, 6, 7, 3C, 3D, 3E and 3F are all stored within segment 156.

Segment 156 may be used to store the states of all the blocks/chips of storage media 138. It is noteworthy that the block states begin from block #1 because block #0 is typically guaranteed to be defect free and is used to store the defective list 148A described above in detail.

The block state may be stored as a 2-bit value indicating the state of each block within storage media 138. As an example, each byte of the NVRAM may be divided into 4 of 2 bits each to store the status of each chip/block. 2 bits may have four possible values (00, 01, 10, 11) that may be used to indicate four different block states. For example, a value of 00 may be used to indicate a defective block; and a value of 01 may be used to indicate an invalid block i.e. has invalid data). A value of 10 may be used to indicate a free block i.e. a block that is erased and may be used to store new data; and a value of 11 may be used to indicate a valid block i.e. the block has good and valid data associated with a host LBA.

As an example, NVRAM 134 may have a base address of 90000000 in hex for a 32 bits machine. The content of 90000001(hex) may be 01100011. This can be translated into the status of chip4/block1=11 (has good data, chip5/block1=00 (defective block, do not use), chip6/block1=10 (block can be use to store new data), chip7/block1=01 (contains old data, need to be erased).

Data structure 150 may also include a reserved segment 158 if there are more bytes in the NVRAM 134 than a number of bytes needed to store the status of all the blocks. The last few bytes (for example, 2) 160 may be used for storing security information. As an example, the security information may include a 2-byte checksum value. The checksum value is updated every time a block changes state. The checksum bytes may be used to match a calculated value when SSD 110A is powered up, as described below in detail.

FIGS. 1G and 1H show various data structures that are resident in DDR 132 but generated using the NVRAM data structure 150, according to one embodiment. Data structure 162 is a mapping structure that maps physical block addresses of storage media 138 and the associated host LBAs for each block address. Data structure 162 includes a segment 162A for storing physical block address offsets of DDR 132 that are used for storing the host LBA/erase count shown in segment 162B. The chip#/block# associated with the host LBA are shown in segment 162C.

As an example, assume that the base address of DDR 132 may be (hex)A0000000 and the address offsets may be in 8 bytes increment. Hence, address (hex)A0000008 may be used to store the erase count of chip0/block1 and (hex)A000000C may be used to store host LBA of chip0/block1. (hex)A0000010 may be used to store the erase count of chip0/block2, while (hex)A0000014 may store the host LBA of chip0/block2.

Micro-processor 130 uses the block states stored in NVRAM data structure 150, along with the erase count and host LBA read from the block to generate data structure 162, after a power failure, as described below in more detail.

Data structure 164 is the reverse of data structure 162 where the host LBA is associated with chip numbers and block numbers of the storage media 138. Segment 164A stores the host LBA and the physical address of DDR 132 in segment 164B is used to store the chip #/block # associated with the host LBAs.

As an example, assume that the physical address of DDR 132 is (hex)B0000000. Then, (hex)B0000000 may be used to store the chip#/block# associated with host LBA[0]. (hex)B0000004 may be used to store the chip#/block# associated with host LBA[1] and so on. Data structure 164 makes it easier to respond to a read/write command that includes the host LBA. It is noteworthy that the adaptive embodiments are not limited to separate data structures 162 and 164. Data structures 162 and 164 may be implemented using just one data structure.

FIG. 1H shows a “to be erased” data structure 166, according to one embodiment. Data structure 166A includes segment 166A, which is the base address of DDR 132 for storing the chip#/block# based on erase count in segment 166B. For example, if the base address is (hex)C0000000, then (hex)C0000000 may be used to store the chip#/block# with the least erase count. (hex)C0000004 may store the chip#/block# with next higher erase count and so on. The data structure 166 may be generated using the state values of NVRAM data structure 150, along with the erase count read from the block, as described below in more detail.

FIG. 1H also shows a “free block” data structure 168 that lists all the free blocks that can be assigned for a new write request. Data structure includes segment 168A, for storing the base physical address/offsets of DDR 132 used for storing the chip#/block# based on erase count (segment 168B). For example, if the base address is (hex)D0000000, then it may be used to store the chip#/block# 168B which has the least erase count and also can be used to write new data. (hex)D0000004 may be used to store the chip#/block# with a next erase count and so forth. In one embodiment, the free block data structure 168 is also generated from the NVRAM data structure 150, as described below in detail with the various process flow diagrams.

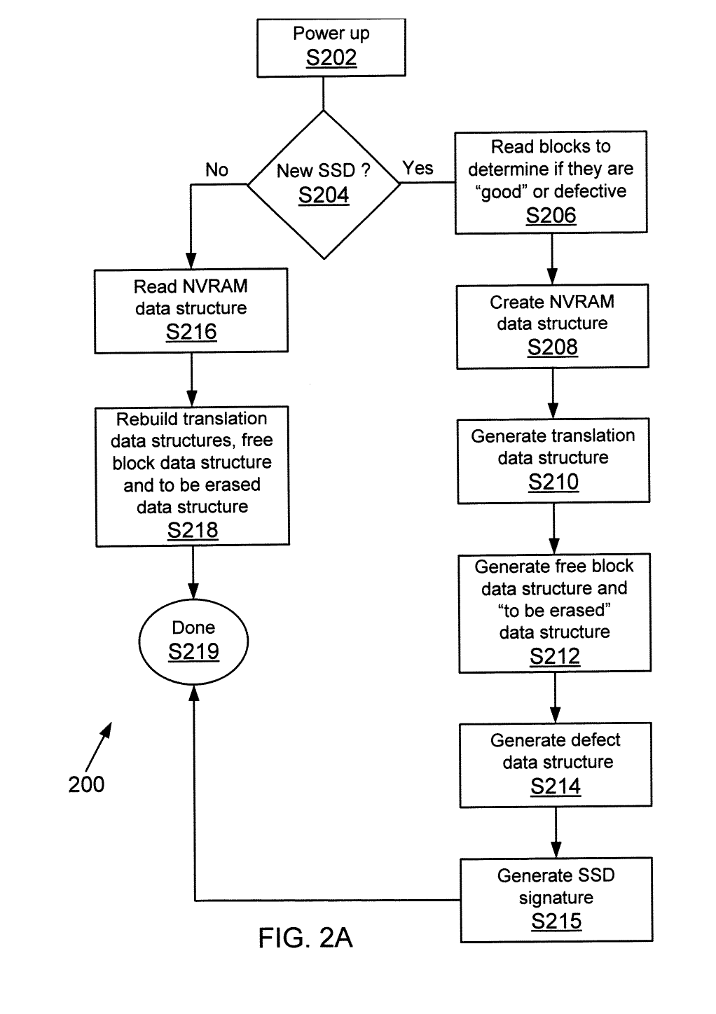

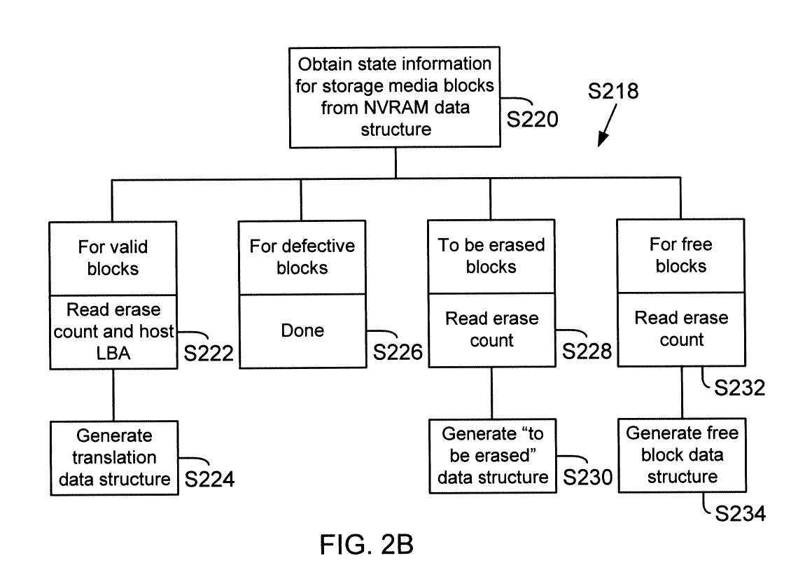

Process Flow: FIG. 2A shows a process 200 for configuring SSD 110A, according to one embodiment. The SSD 110A is powered up using the power module 126 that may not include or use the capacitor 120 and sensing circuit 118 shown in FIG. 1B. After power up, in block S204, micro-processor 130 determines if the SSD 110A is new. Typically, a unique digital signature is used to identify a SSD 110A. This unique digital signature is typically stored in the SSD 110A after the defects are read, a defect list is created and the SSD can start operating for reading and writing information. If the unique signature is not found by micro-processor 130 executing firmware instructions, then micro-processor 130 assumes that the SSD is a new SSD.

When the SSD 110A is new, then in block S206, micro-processor 130 reads each block of each chip of storage media 138 and determines if the block is defective. A defect list of each chip is created and stored in block #0 of the chip because block #0 is typically guaranteed to be defect free. Thereafter, the NVRAM data structure 150 is generated in block S208. Initially, all the blocks in NVRAM data structure 150 will have two states, defective or free, since nothing has been written yet. Details regarding NVRAM data structure 150 have been provided above with respect to FIG. 1F.

In block S210, the translation (or mapping) data structures 162 and 164 (FIG. 1G) are generated. Initially, since the translation data structures are created for the first time, the host LBA field is irrelevant because the blocks of the storage media 138 are either free or defective. Erase count for the blocks is also set to zero since the blocks have not yet been erased. Details regarding the mapping data structures have been provided above with respect to FIG. 1G.

In block S212, the free block data structure 168 and to be erased data structure 166 are generated by the micro-processor 130. All the free blocks are included in the free block data structure 168 (FIG. 1H) and the “to be erased data” structure 166 (FIG. 1H) is empty because none of the blocks have been written.

A data structure (not shown) listing all the defects at storage media 138 is also generated in block S214. The defect list may be used for reformatting the SSD 110A, the details of which are not germane to adaptive embodiments disclosed herein.

Micro-processor 130 then creates a unique digital signature for SSD 110A in block S215. The unique digital signature is stored at storage media 138. The digital signature indicates that SSD 110A is ready for use. So next time, when SSD 110A is powered up, the digital signature will indicate that the SSD 110A is ready for use. Thereafter, the process is done in block S219.

It is noteworthy that there may be other configuration/formatting process steps but they are not germane to the adaptive embodiments and hence they have not been described.

If the SSD 110A is not new as determined in block S204, then in block S216, the NVRAM data structure 150 is read by micro-processor 130 to determine the state of the various blocks of storage media 130. One reason for executing this process block is that translation data structures 162/164 may have been lost due to a power loss or failure. The NVRAM data structure 150, however is quite reliable since it is stored in non-volatile memory.

In block S218, the translation data structures 162 and 164, as well as the “to be erased” data structure 166 and the free block data structure 168 are rebuilt using the NVRAM data structure 150. The details of rebuilding the data structures are now provided with respect to FIG. 2B.

To rebuild the various data structures described above, first the state information regarding all the blocks is obtained from NVRAM data structure 150. The state information is determined by micro-processor 130.

To determine the state of a block, the micro-processor 130 should know the byte offset from a base of an NV-RAM address and the position of each status bit. For example, as explained above, the NVRAM may use 8 bits to store the state of 4 different blocks. The positions, 0-3, of the blocks may be determined by using the following equations: (a) Byte offset=(blk#−1)×10+(chip#/4)quotient

(b) Position=(chip#/4)remainder

For example, for chip0, blk1, the offset and the position maybe determined as follows:

offset=0+0/4(quotient)=0

position=0/4(remainder)=0

The embodiments described herein are not limited to any specific technique for determining the offset and the position.

As described above, each block maybe in one of four states, i.e. defective, invalid, valid and free. Based on the state, the micro-processor 130 takes the appropriate steps to build the data structures. For example, for valid blocks, in block S222, micro-processor 130 obtains the associated LBA and erase count for each block with a valid state from the storage media 138 via media controller 136. As described below, when data is written at a certain block, the host LBA is also written in the block with the data. The erase count for each block is also maintained at block #0 of each chip. The media controller 136 provides the information to micro-controller 130 that then updates data structures 162 and 164.

For defective blocks, nothing is done, as shown in block S226.

For blocks that need to be erased, in block S228, micro-processor 130 obtains the erase count from storage media 130 via media controller 136. Thereafter, in block S230, the “to-be” erased data structure 166 is updated. As described below, the blocks that need to be erased are erased when micro-controller 130 is not busy responding to read/write commands.

For blocks that are free, in block S232, the erase count of those blocks is obtained by the micro-processor 130 from the storage media 138. The free block data structure 168 is updated so that blocks can be assigned for processing new write requests. As described above, the free block data structure 168 stores block information with the erase count so that blocks with the lower erase count are allocated first compared to blocks with higher erase counts.

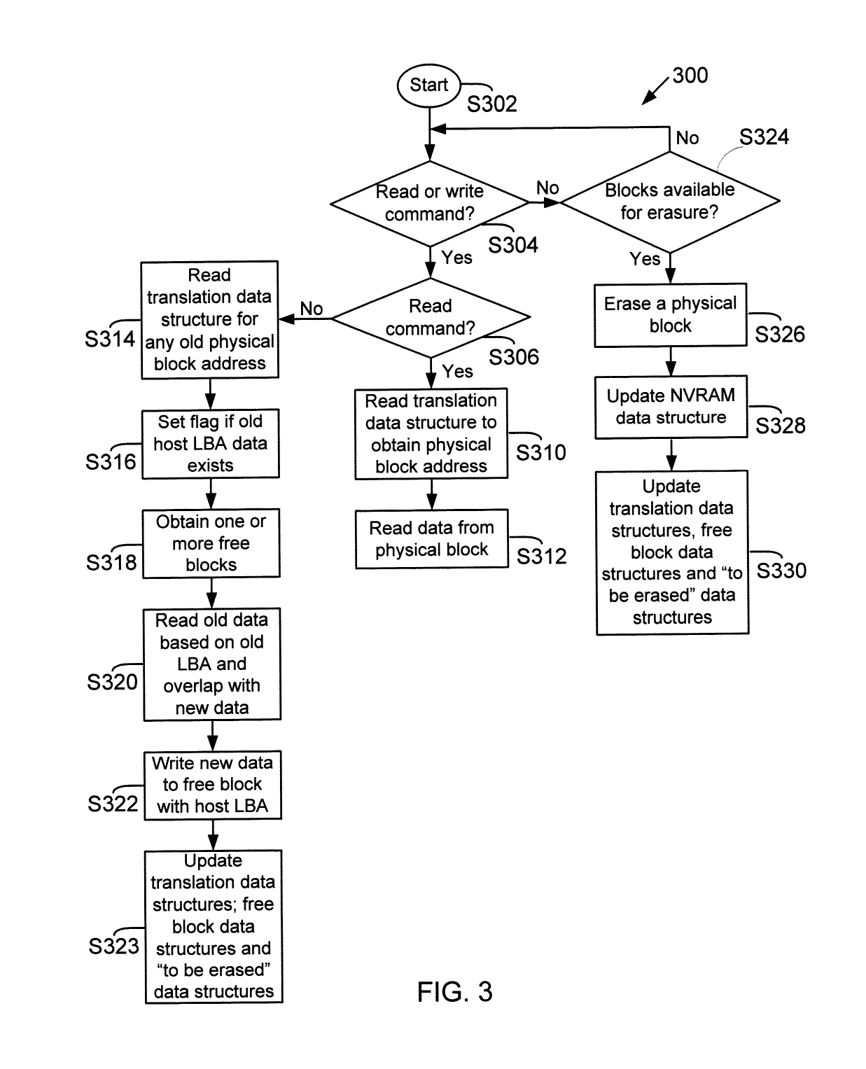

FIG. 3 is a process 300 for using SSD 110A using the embodiments/data structures described above. The process begins in block S302 and in block S304, the micro-processor 130 determines if it has received a read or write command. If a read command is received, as determined in block S306, the micro-processor 130 reads the translation data structure 164 in block S310 to obtain the physical block address. The data is then read by the media controller 136 and provided to the host system processor 102 in block S312.

If the command is a write command, as determined in block S306, then the process moves to block S314 where the translation data structure 166 is read to determine if there are any “old” blocks associated with the write command. The write command may involve an “old” physical block address, which may store previously written data. The write command may be a request to update part of an old block data. Therefore, the micro-processor 130 may need to read the old block data, overlap part of the old data with new data, and write the entire block of data to a new free block. The old block will then be erased later. The micro-processor 130 first reads data structure 164 to get the chip#/block# in block S314. Then it uses data structure 162 to get the erase count and host LBA. If the host LBA is a valid one, then an old block is involved with the write command. If an old block exists, then in block S316, a flag is set for the old block indicating that the write command involves reading the old block and merging new write data.

A free block is then obtained in block S318 from data structure 168. Because data structure 168 stores addresses based on erase count, as described above, a block with the least erase count is selected.

In block S320, if the host only wants to write part of the block while keeping part of old data in the block, then old data is read using the old LBA. The new data is then overlapped with the old data to form a block of merged data held in a temporary memory buffer (not shown).

In block S322, the new data, or merged data is written at the block selected in step S318. The new host LBA is also written with the data to the free block. With the new chip#/block# now associated with the host LBA, and the old chip#/block# containing data invalid, micro-processor 130 can update data structures 162, 164, 166 and 168. Data structure 150 is also updated so that it can be used to rebuild other data structures in case there is a power failure.

If the command is neither a read or write command, as determined in block S304, the process moves to block S324, when the micro-processor 130 determines if there are blocks that need to be erased. The blocks that need to be erased are arranged in an order of least erased count to highest erase count in the “to be erased” data structure 166. This ensures that blocks with lower erase count are erased first compared to blocks with higher erase counts. If no blocks are available, then the process moves back to block S304.

When a block is available for erasure, then it is erased in block S326 and the erase count for the block is updated at storage media 138. The NVRAM data structure 150 is also updated to indicate that the erased block state has changed. The translation data structure 162 is updated in block S330 to indicate the new erase count, and the host LBA becomes invalid after the erasure. The erased block information is then removed from the “to-be erased” data structure 166 and the block is added to the free block data structure 168 to indicate that the erased block is now available for allocation.

The embodiments disclosed above have various advantages. For example, one does not need a capacitor for rebuilding translation data structures. By managing erase counts, one is able to control wear at the storage media, extending the life of the SSD 110A.

Thus, methods and system for storage devices have been described. Note that references throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics being referred to may be combined as suitable in one or more embodiments of the invention, as will be recognized by those of ordinary skill in the art.

While the present disclosure is described above with respect to what is currently considered its preferred embodiments, it is to be understood that the disclosure is not limited to that described above. To the contrary, the disclosure is intended to cover various modifications and equivalent arrangements within the spirit and scope of the appended claims.

What is claimed is:

1. A non-volatile mass memory storage device for storing information for a computing device, comprising;
a storage media having a plurality of non-volatile memory storage blocks for storing information; and
a micro-processor having access to a non-volatile memory for storing a non-volatile data structure used for storing a plurality of states for the plurality of storage blocks;
wherein the plurality of states include a first state indicating that one or more of the plurality of blocks are defective; a second state indicating that one or more of the plurality of blocks are valid and are being used to store information; a third state indicating that one or more of the plurality of blocks are free for allocation to store information; and a fourth state indicating that one or more of the plurality of blocks are invalid and are ready to be erased; and
wherein when the storage device is powered up, state information is used to rebuild a translation data structure used by the micro-processor for responding to read and write requests for reading and writing information.

2. The storage device of claim 1, wherein the translation data structure is stored at a volatile memory of the storage device.

3. The storage device of claim 1, wherein the translation data structure stores a logical block address (LBA) corresponding to a chip number and a block number of the storage media.

4. The storage device of claim 3, wherein the LBA is sent by the computing device to read and write information at the storage media.

5. The storage device of claim 1, wherein the translation data structure stores an erase count of each block of the storage media used for generating a “to be” erased data structure for identifying blocks of the storage media that need to be erased at a given time.

6. The storage device of claim 5, wherein a block with a lower erase count is erased first compared to a block with a higher erase count.

7. The storage device of claim 5, wherein the erase count of each block of the storage media is used for identifying blocks of the storage media that are available for allocation for writing information at any given time.

8. The storage device of claim 7, wherein a block with a lower erase count is allocated first for writing compared to a block with a higher erase count.

9. A non-volatile mass memory storage device for storing information for a computing device, comprising;
a storage media having a plurality of non-volatile memory storage blocks for storing information; and
a non-volatile memory for storing a non-volatile data structure used for storing a state of the plurality of storage blocks indicating that one or more of the plurality of blocks are defective;
one or more of the plurality of storage blocks are valid and are being used to store information; one or more of the plurality of storage blocks are free for allocation to store information; and one or more of the plurality of blocks are invalid and are ready to be erased; and
wherein when the storage device is powered up, state information is used to rebuild a translation data structure stored at a volatile memory device and used for responding to read and write requests for reading and writing information at the storage media.

10. The storage device of claim 9, wherein the translation data structure stores a logical block address (LBA) corresponding to a chip number and a block number of the storage media.

11. The storage device of claim 10, wherein the LBA is sent by the computing device to read and write information at the storage media.

12. The storage device of claim 9, wherein the translation data structure stores an erase count of each block of the storage media for generating a “to be” erased data structure for identifying blocks of the storage media that need to be erased at a given time.

13. The storage device of claim 12, wherein a block with a lower erase count is erased first compared to a block with a higher erase count.

14. The storage device of claim 12, wherein the erase count of each block of the storage media is used for identifying blocks of the storage media that are available for allocation for writing information at any given time.

15. The storage device of claim 14, wherein a block with a least erase count is allocated first for writing compared to a block with a higher erase count.

16. A non-volatile mass memory storage device for storing information for a computing device, comprising;
a storage media having a plurality of non-volatile memory storage blocks for storing information;
a non-volatile memory for storing a non-volatile data structure for storing a state of the plurality of storage blocks indicating whether a block is defective, valid, invalid or free; and
a volatile memory for storing a translation data structure for responding to read and write requests for reading and writing information at the storage media;
wherein when the storage device is powered up, the state information is used to rebuild the translation data structure.

17. The storage device of claim 16, wherein the translation data structure stores a logical block address (LBA) corresponding to a chip number and a block number of the storage media.

18. The storage device of claim 16, wherein the translation data structure stores an erase count of each block of the storage media for generating a “to be” erased data structure for identifying blocks of the storage media that need to be erased at a given time and wherein, a block with a lower erase count is erased first compared to a block with a higher erase count.

19. The storage device of claim 18, wherein the erase count of each block of the storage media is used for identifying blocks of the storage media that are available for allocation for writing information at any given time.

20. The storage device of claim 19, wherein a block with a least erase count is allocated first for writing compared to a block with a higher erase count.
